(19) United States
(12) Patent Application Publication
(10) Pub. No.: US 2022/0180693 A1
(43) Pub. Date: Jun. 9, 2022

(54) GAMING TERMINAL SUPPORTING SIMULTANEOUS PLAY OF MULTIPLE GAMES

(71) Applicant: Craig K. Potts, Scottsdale, AZ (US)

(72) Inventor: Craig K. Potts, Scottsdale, AZ (US)

(21) Appl. No.: 17/643,167

(22) Filed: Dec. 7, 2021

Related U.S. Application Data
(60) Provisional application No. 63/122,320, filed on Dec. 7, 2020.

(51) Int. Cl. G07F 17/32; A63F 3/06

(52) U.S. Cl. CPC G07F 17/3211; A63F 3/0645; G07F 17/3216

(57) ABSTRACT

To provide additional playing opportunities for users, a game console is configured to have multiple display devices which are capable of playing separate games. A controller will coordinate play of the games to insure they comply with the rules of the jurisdiction where the console is installed.

### BACKGROUND

Creating excitement and opportunity for individuals is a constant goal for those involved in the casino and gaming industry. One portion of this activity is the creation of new games and/or opportunities, which increases excitement and desire for users, thus providing new entertainment options for many individuals. Further, creating new games and new gaming opportunities which are easy to understand while also enticing can always be challenging and rewarding at the same time.

Electronic gaming has been widely popular for many years and continues to evolve, providing playing opportunities for many. Gaming consoles or gaming systems can take many forms, depending on the jurisdiction or philosophy involved.

Bingo gaming devices and pull-tab gaming devices are two well-known versions of electronic gaming consoles which are accepted in several jurisdictions. Games of chance have also existed and are widely prevalent in other jurisdictions, along with lottery games, games of skill and sweepstakes games. All of these are generally understood and recognized by many different participants and are games which can be easily incorporated in both an electronic version or a paper version. That said, variations and further modifications of well-known games provides additional reasons for users and/or participants to be excited.

### SUMMARY

To provide added excitement and opportunity, a gaming console is configured to support the simultaneous play of multiple games for a single user. While several variations are possible, some of the contemplated embodiments this will support the simultaneous play of multiple pull-tab games, multiple bingo games, multiple lottery games, multiple sweepstakes games, multiple skill games, multiple nudge games, or multiple versions of other games that can be played on a video gaming console.

### BRIEF DESCRIPTION OF THE DRAWINGS

FIG. 1 presents a front view of a gaming console;

FIG. 2 is a schematic diagram of the electronic components contained within the gaming console; and

FIG. 3 shows an alternative game console that accommodates the simultaneous playing of two games.

### DESCRIPTION

In an effort to provide additional gaming opportunities for users, the embodiments disclosed herein provide multiple display screens on a gaming console, which allows or supports the simultaneous play of multiple games. In one embodiment, two displays or screens are presented to the user, one display playing a first game while the second display allows for the play of a second game. In one embodiment, these are simultaneous pull-tab based games, which can be designed and configured to have user interfaces which widely vary. In another embodiment, Bingo-type games are incorporated, again allowing for the simultaneous play of two games by a single user at the same time. As discussed in more detail below, many alternatives and combinations are possible.

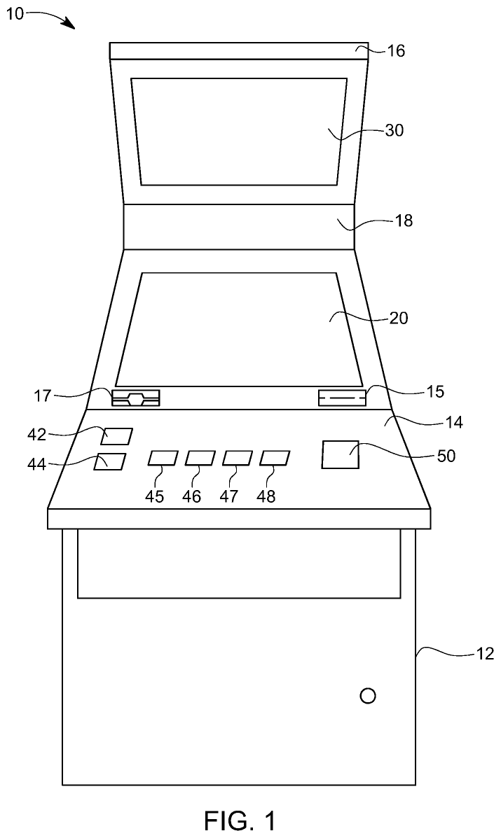

Turning now to FIG. 1, one example embodiment of a gaming console 10 is illustrated. As shown, gaming console 10 includes a main housing 12 which is configured to support a number of separate components. In particular, housing 12 supports a control panel 14, a first display 20 and a second display 30. Housing 12 also supports a banner panel 16, which is generally configured to support advertising or promotional signage. Housing 12 also supports a speaker panel 18 which houses audio speakers, thus allowing for sound effects to be incorporated into the user's gaming experience. Also supported by housing 12 is a bill exchanger 15 and a ticket printer 17. As will be recognized, bill exchanger 15 is configured to accept currency, and may also be configured to accept printed tickets or vouchers of various types. In a similar manner, printer 17 is configured to print vouchers or payment tickets, generally when a user desires to cash out.

As also illustrated, control panel 14 includes a number of control buttons which generally provide a user interface, allowing a user to provide appropriate playing commands. In this particular embodiment, control panel 14 includes a pair of game select buttons 42 and 44. As will be discussed in further detail below, game control buttons 42 and 44 provide a user with the ability to select an upper game or a lower game. Further, control panel 14 includes a collection of bet amount buttons 45, 46, 47 and 48. These bet amount buttons 45-48 provide a user with the ability to easily select an amount for the desired wager or bet while games are being played. Also supported on control panel 14 is a play button 50 which is generally configured to allow play to commence, once all playing options are selected.

As mentioned above, game console 10 of the disclosed embodiment includes first display 20 and second display 30. It is generally contemplated that first display 20 and second display 30 will accommodate the simultaneous play of multiple games, by a user interacting with the gaming console 10. In this embodiment, it is generally contemplated that first display 20 and second display 30 could be configured as any well-known display device. Further, first display 20 and second display 30 could be touchscreen enabled displays, thus allowing further user interaction with game console 10.

The display devices (e.g. first display 20 and second display 30) used in gaming device 10 can vary in design and operation. These display devices could include well known display devices such as Liquid Crystal Displays (LCD), LED monitors, etc. It is also possible to carry out the necessary game play using multiple separate display devices, or a single display device partitioned into a plurality of displays. Further, it is contemplated that the first display 20 and second display 30 could be configured as touchscreen displays, thereby allowing user input by simply touching appropriate areas of the screens.

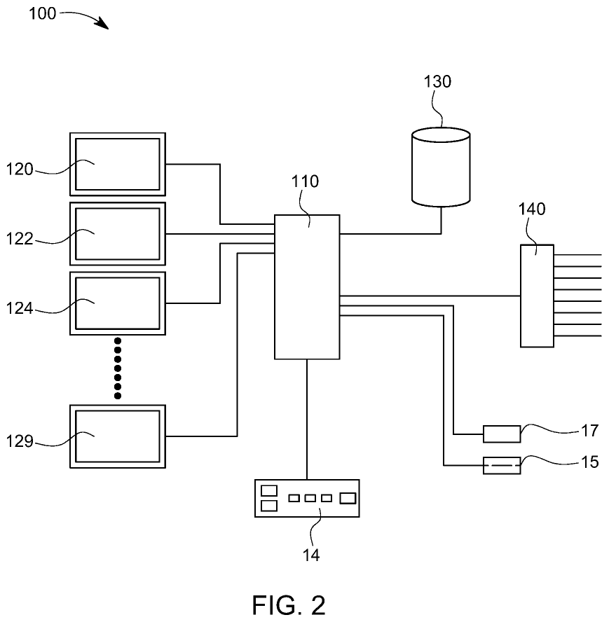

Turning now to FIG. 2, a schematic diagram is presented showing the internal components of the gaming system. Generally, it is contemplated that all components would be contained within a housing 12, similar to that discussed above. More specifically, the gaming system 100, generally illustrated in FIG. 2, comprises a processor 110, a plurality of display devices 120, 122, 124, . . . , 129 a memory device 130 and network interface 140. It is contemplated that each of these display devices 122 through 129 would be contained within a gaming console 10 similar to that discussed above. As this illustrates, it is contemplated that any number of display devices could be included, all of which are operatively connected to processor 110. As also illustrated, processor 110 is operatively connected to control panel 14, thus allowing it to receive electrical signals indicative of player commands. Further, processor 110 is operatively connected to bill exchanger 15 and printer 17, also allowing for the coordinated operation of those components.

As generally discussed below, processor 110 will coordinate game operations for gaming system 100. In order to generally carry out this function, processor 110 will communicate with memory device 130 as needed. Further, to provide additional features and functionality, processor 110 is connected to a network interface 140, thus allowing further communication with other components and other systems.

In the examples discussed herein, it will be apparent that gaming system 100 is specifically configured to allow many variations in game play, while also providing the specific ability for users to simultaneously play multiple games. In the embodiment generally illustrated in FIG. 1, gaming console 10 is configured to accommodate the simultaneous play of two different games. Alternatively, gaming system 100 schematically illustrated in FIG. 2 includes multiple monitors, thus allowing for multiple games to simultaneously be played by the user in a similar manner.

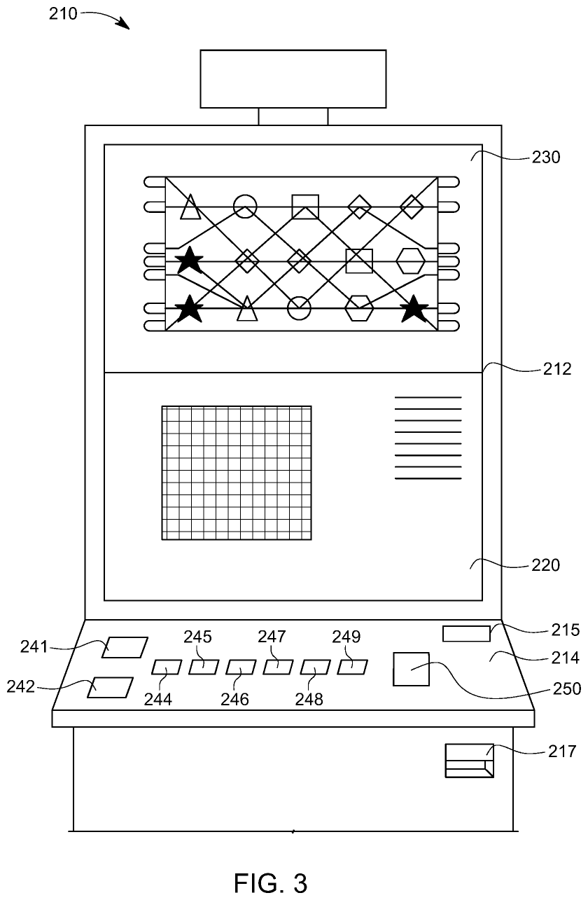

Turning now to FIG. 3, an alternative gaming console 210 is illustrated. In this embodiment, a single display device 212 is partition into a first display section 220 and a second display section 230 to support the play of two simultaneous games. As illustrated, first display section 220 is used to accommodate a Keno game, while second display section 230 is used to support a seven-line slot game. Play of the game is accomplished by player interaction with a control panel 214, which supports game select buttons 241 & 242, bet buttons 244-249 and play button 250. Game console 210 also supports a bill acceptor 215 and a printer 217.

Although not shown, a processor is housed within alternative game console 210 which is configured to coordinate the operation of display device 212. It will be further understood that the processor can incorporate the game requirements required by the particular jurisdiction. Again, this could include bingo-based games, pull-tab based games, games of chance, etc. The processor within console 210 will be specifically programmed to follow the rules/requirements of these jurisdictions. For example, a pull-tab based game could be presented in an upper portion of display 212, while a second pull-tab based game is presented in a lower portion. Alternatively, the first game and second game could be based upon a single pull-tab based deck, as directed by the particular jurisdiction. Similar rule would be followed if the first game and second game are bingo based games—the first game might be based upon a first bingo draw or drop (i.e. simulated bingo drop or set of bingo numbers), while the second game may be based upon a second bingo draw or drop. Alternatively, both games may be based upon a single set of bingo numbers. Further, the odds for the various games can be adjusted to meet the desires and requirements of the game designers.

Various embodiments of the invention have been described above for purposes of illustrating the details thereof and to enable one of ordinary skill in the art to make and use the invention. The details and features of the disclosed embodiment[s] are not intended to be limiting, as many variations and modifications will be readily apparent to those of skill in the art. Accordingly, the scope of the present disclosure is intended to be interpreted broadly and to include all variations and modifications coming within the scope and spirit of the appended claims and their legal equivalents.

1. A gaming machine configured to allow a user to participate in multiple games, the gaming machine comprising:
a housing;
a first display supported by the housing and positioned to be easily viewable by the user;
a second display also supported by the housing and positioned to be easily viewable by the user;
a user interface configured to allow player interaction with the gaming machine;
a processor contained within the housing and operatively coupled to the user interface, the first display and the second display; and
memory configured to store programming that will allow the processor to facilitate the play of a first game using the first display and a second game using the second display, wherein play of the first game and play of the second game are controlled by the user interface, and wherein the first game and the second game can be played simultaneously.

2. The gaming machine of claim 1 wherein the first game and the second game follow a plurality of predetermined rules and thus are compliant with gaming rules of the jurisdiction where the game console is installed.

3. The gaming machine of claim 2 wherein the first game and the second game are bingo games.

4. The gaming machine of claim 3 wherein the first game and the second game rely upon a single bingo draw.

5. The gaming machine of claim 4 wherein the first game is configured as a base game and the second game is configured to appear as a progressive game.

6. The gaming machine of claim 2 wherein the first game and the second game are pull-tab based games.

7. The gaming machine of claim 6 wherein the first game and the second game rely upon a single pull-tab deck.

8. The gaming machine of claim 1 wherein the first display and the second display are presented on a single display device which is partition to display the first game in a first portion of the single display device while presenting the second game in a second portion of the single display device.

9. The gaming machine of claim 1 wherein the first game and the second game are controlled by the user operating a single user interface.

10. The gaming system of claim 1 further comprising a speaker system to provide an audio output corresponding to the first game and the second game.

11. A gaming system configured to allow a user to simultaneously play multiple games, comprising:
a plurality of display screens;
a user interface configured to allow the user to input user commands;
a memory device; and
a host processor operatively coupled to the user interface to receive user commands, the plurality of display screens to display information, and the memory device;
wherein the memory device contains instruction with will cause the host processor to facilitate the simultaneous play of a plurality of games using the plurality of display screens and as controlled by the user interface, and wherein the plurality of game follow a set of predetermined jurisdictional rules.

12. The gaming system of claim 11 wherein the plurality of games were based upon a single set of jurisdictional rules.

13. The gaming system of claim 12 wherein the single set of jurisdictional rules required each of the plurality of games to be based upon a bingo draw.

14. The gaming system of claim 12 wherein the single set of jurisdictional rules required each of the plurality of games to be based upon a pull-tab deck.

15. The gaming system of claim 12 wherein the plurality of display screens are each separate display devices.

16. The gaming device of claim 15 wherein the display devices are contained in a plurality of housings, with each housing having at least two display devices.

17. The gaming device of claim 16 wherein each housing comprises a housing processor configured to communicate with the host processor and thereby facilitate the simultaneous play of the plurality of games.
